(19) United States
(12) Patent Application Publication
(10) Pub. No.: US 2017/0243188 A1
(43) Pub. Date: Aug. 24, 2017

(54) POINT OF SERVICE USER IDENTIFICATION

(71) Applicant: Qi-Leap Analytics Inc., Vancouver (CA)

(72) Inventors: Mohammad Mahmoudzadehvazifeh, Medford, MA (US); Poya Haghnegahdar, North Vancouver (CA); Alireza Haghnegahdar, Vancouver (CA); Ehsan Mahmoudzadehvazifeh, West Vancouver (CA)

(21) Appl. No.: 15/436,461

(22) Filed: Feb. 17, 2017

Related U.S. Application Data
(60) Provisional application No. 62/297,018, filed on Feb. 18, 2016.

(51) Int. Cl. G06Q 20/20; G06Q 20/32

(52) U.S. Cl. CPC G06Q 20/202; G06Q 20/3278

(57) ABSTRACT

Systems and methods are described for identifying users of a network-enabled point of service (“POS”) without requiring the POS to collect user identifying information. A mobile computing device detects a POS identifier (“POS-ID”) associated with a POS device. The mobile computing device transmits information including the POS-ID to a user identification server. The network-enabled POS device transmits further information including transaction data to the user identification server. The user identification server compares the data received from the POS device and the data received from the mobile computing device to determine a correlation and identify the POS and the user as parties to a transaction. The user identification server may determine which of several POS devices and/or users were parties to a transaction, and may provide information regarding the correlated transactions to the POS, the user, or to authorized third parties.

### CROSS-REFERENCE TO RELATED APPLICATION

This application claims the benefit of U.S. Provisional Application No. 62/297,018, entitled POINT OF SERVICE USER IDENTIFICATION, and filed Feb. 18, 2016, the entire disclosure of which is hereby incorporated by reference herein.

### BACKGROUND

Generally described, Point of Service devices (“POS devices”) may obtain information that identifies a user or potential user requesting a service. Conventional POS devices may obtain user identifying information from, for example, an input device that reads a magnetic card stripe, or one that accepts data entry of a telephone number, account number, email address, or other identifier. However, such approaches require the requesting user to carry the necessary magnetic card or remember which identifier to use with a particular POS device.

Advanced POS devices may also interact with mobile computing devices to obtain user identifying information, or may identify a mobile computing device and associate it with user identifying information. For example, a POS device may detect a mobile computing device that transmits an identifier via Wi-Fi, Bluetooth, or near field communication (NFC), or that presents a visual identifier, such as a bar code or QR code, to a scanner attached to the POS device. The identifier may be associated with the mobile computing device (e.g., a MAC address or telephone number), or with a particular user or user account. However, these approaches typically require the service provider to upgrade existing POS devices and maintain databases of device information and user information, which in turn leads to cost, security, and privacy issues for the provider of the service.

### BRIEF DESCRIPTION OF THE DRAWINGS

The foregoing aspects and many of the attendant advantages will become more readily appreciated and understood by reference to the following detailed description, when taken in conjunction with the accompanying drawings, wherein:

FIG. 1 is a schematic block diagram of an illustrative network topology including a point of service computing device, a point of service identifier, a mobile computing device, and a networked user identification server.

FIG. 2 is a flow diagram depicting an illustrative routine for collecting point of service transaction data and user identifying information, as carried out by a networked user identification server in accordance with the present disclosure.

FIG. 3 is a flow diagram depicting an illustrative routine for processing detection of a point of service identifier, as carried out by a mobile computing device in accordance with the present disclosure.

FIG. 4 is a flow diagram depicting an illustrative routine for associating transaction data with user identifying information, as carried out by a networked user identification server in accordance with the present disclosure.

FIG. 5 is a schematic block diagram depicting a general architecture of an example mobile computing device configured to implement aspects of the present disclosure.

### DETAILED DESCRIPTION OF SPECIFIC EMBODIMENTS

Aspects of the present disclosure allow a network-enabled point of service device (“POS device”) to identify individual users or clients. Examples of POS devices include, but are not limited to, point of sale terminals operated by physical merchants, “smart home” devices such as door locks and thermostats, sensor-equipped vehicles, and other devices that provide or facilitate providing services to customers. Customers may be identified without the POS device having to collect personal information from the customers, and without replacing or upgrading existing POS devices. As described in more detail below, a POS identifier may be deployed with an existing POS device. The POS identifier may be recognized by a mobile computing device associated with a user of the POS device, and both the POS device and the mobile device may transmit information to a networked user identification server. The networked user identification server may use the information received from both devices to associate POS transactions with particular users.

Aspects of the present disclosure are thus directed to identifying users of a network-enabled POS device. More specifically, aspects of the present disclosure correspond to systems, methods, and computer-readable media related to a networked user identification server, e.g., a service that identifies users or clients and matches them with corresponding transaction data from a network-enabled POS device. Illustratively, a POS device may collect transaction data regarding purchased items, device settings, recorded interactions, or other data associated with a user. In an aspect, the POS device may associate transaction data with a user, but may not collect or retain sufficient information to identify the particular user. For example, the POS device may collect transaction data indicating that a set of items were purchased by a user, but may do so without collecting (or, in some aspects, retaining) information that would identify the particular user.

The POS device may transmit the collected transaction data via a network or networks, such as the Internet, to a networked user identification server. The networked user identification server may store the transaction data, and may collect and store additional information to associate with the transaction data. For example, the networked user identification server may associate a POS identifier with transaction data received from a particular network address, or may associate a timestamp with the transaction data based on the time at which it is received. In some embodiments, the POS device may transmit a timestamp or POS identifier with the transaction data, or may identify itself with, for example, a login and password.

Transaction data is generally defined as data associated with actions and behaviors of users at a POS device. As an example, transaction data can be a list of items purchased by shoppers at a point of sale (an example of a POS) in a physical store. As a further example, transaction data can be associated with user behavior in a physical environment, which may be collected by sensors or through user interaction with a device. For example, transaction data may be collected by sensors in a vehicle, and may include user settings (e.g., seat positions, radio stations, and so forth), driving habits, or other activity. As a still further example, transaction data may be collected by sensors in smart locks, doors and buildings. One skilled in the art will thus appreciate that the present disclosure is not limited to any particular type or source of transaction data.

In some embodiments, the POS device or the networked user identification server may process the transaction data. For example, the POS device may identify a series of transactions that relate to the same user, although the identity of the user is not known to the POS device. The POS device processes the data to specify that these transactions should all be associated with a common user. As a further example, the networked user identification server may identify patterns in the transaction data that indicate whether transactions have a common user, and may process the transaction data accordingly.

The POS device may be associated with a POS identification (POS-ID) tag. The POS-ID tag may illustratively be any device, symbol, or other identifier that can be read by a mobile computing device. As non-limiting examples, the POS-ID tag may be a Near Field Communications (NFC) tag, a bar code, a QR code, a Bluetooth device, an “iBeacon” or other Bluetooth LE device, or a Wi-Fi SSID. The POS-ID tag may be read or detected by a mobile computing device associated with the user. In embodiments where the mobile computing device can detect more than one POS-ID tag, the mobile computing device may determine the nearest POS-ID tag using signal strength measurements or other criteria, or may prompt the user for input that identifies the POS device. The POS-ID tag may further correspond to an alphanumeric string associated with the POS device, such as an account identifier or code that identifies the POS device to the networked user identification server.

In some embodiments, the mobile computing device may prompt the user to perform an action in response to reading the POS-ID tag. For example, the mobile computing device may prompt the user to load an application or visit a web page on the mobile computing device. In other embodiments, the mobile device may be configured to perform an action in response to reading a POS-ID tag, without requiring input from the user.

The mobile computing device may then transmit the detected POS-ID tag to the networked user identification server. In some embodiments, the mobile computing device may further transmit a timestamp, user identifier, or other information along with the POS-ID. In other embodiments, the networked user identification server may associate a timestamp, user identifier, or other information with the received POS-ID tag. In further embodiments, the mobile computing device may transmit an indication of a duration or a time interval. For example, the mobile computing device may transmit that it detected the POS-ID tag “64221” on Jan. 25, 2016 from 10:06 a.m. to 10:14 a.m., or that it detected the POS-ID tag “Eastside Motors” for eight minutes starting at 10:06 a.m.

The networked user identification server may associate the user identifier or the mobile computing device with particular transactions in the transaction data. Illustratively, the networked user identification server may associate the user identifier with transaction data by comparing timestamps, by comparing POS-ID tags to other information identifying the POS device, or by combinations of both. For example, the networked user identification server may receive transaction data from a POS device that includes transaction #1 at 3:34 p.m., transaction #2 at 3:39 p.m., and transaction #3 at 3:58 p.m. The networked user identification server may also receive data from a mobile computing device indicating that it detected a POS-ID tag associated with the POS device at 3:38 p.m. Based on the timestamps and on the association between the POS device and the POS-ID tag, the networked user identification server may associate transaction #2 with the mobile computing device. Associating or matching users with transactions may be based on different algorithms depending on the use case, the specific POS device, the transaction method, user interaction data, or other information.

In some embodiments, the networked user identification server may assign a confidence level to its matching of a user to a transaction. For example, the networked user identification server may assign a high confidence to a matching in which the timestamp of the transaction and of detecting the POS-ID tag are within a relatively small interval of each other, or may assign a low confidence to a matching in which the timestamps are relatively far apart. The networked user identification server may further adjust its confidence score based on other characteristics of the received data, as described above. In further embodiments, the networked user identification server may determine that an adjusted confidence score has fallen below a threshold, and accordingly may remove the association between the user and the transaction

The networked user identification server may respond to requests to identify users. For example, a POS device may transmit a transaction, or a transaction identifier, to the networked user identification server, and request the identity of the user who conducted the transaction. The networked user identification server may associate a user with the transaction as described above, and may provide information identifying the user to the POS device. In some embodiments, the networked user identification server may apply rules or other criteria to determine whether the user permits identification, or may transmit the request to the mobile computing device and prompt the user to approve the request.

The networked user identification server may respond to requests to provide transaction data. For example, a user may transmit a POS-ID tag via the mobile computing device and request a list of recent transactions involving that user and the POS device associated with the POS-ID tag. The networked user identification server may then respond by providing the requested list of transactions. In some embodiments, a third party may be authorized to access all transaction data associated with a user, or to access transaction data associated with a user and with particular POS-ID tags. For example, a dietician or a meal planning application may be authorized to access all transactions of a particular user that relate to food. The networked user identification server may identify POS-ID tags associated with restaurants, grocery stores, and other similar categories, and may provide (either proactively or in response to a request) lists of transactions involving the user and the food-related POS-ID categories. As a further example, a provider of services may operate multiple POS devices, and may have permission to access all transactions or aggregate transaction information regarding the operated POS devices. As a still further example, a user may authorize two independent POS device operators to access information regarding user transactions on the other POS device.

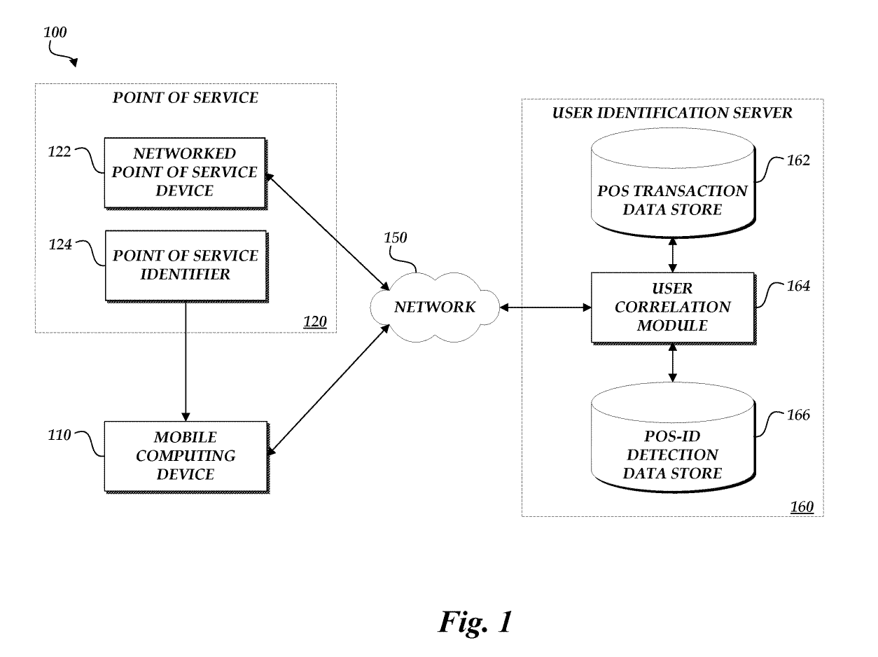

FIG. 1 depicts an illustrative network topology 100 including a mobile computing device 110, a point of service 120, and a user identification server 160 that communicates with the mobile computing device 110 and the point of service 120 via a network 150. It will be understood that the network topology 100 may include more (or fewer) elements than those depicted in FIG. 1, and that it is not necessary that all of these elements be shown in order to provide an enabling disclosure. For example, the network topology 100 may include multiple points of service 120, multiple mobile computing devices 110, and/or multiple networks 150.

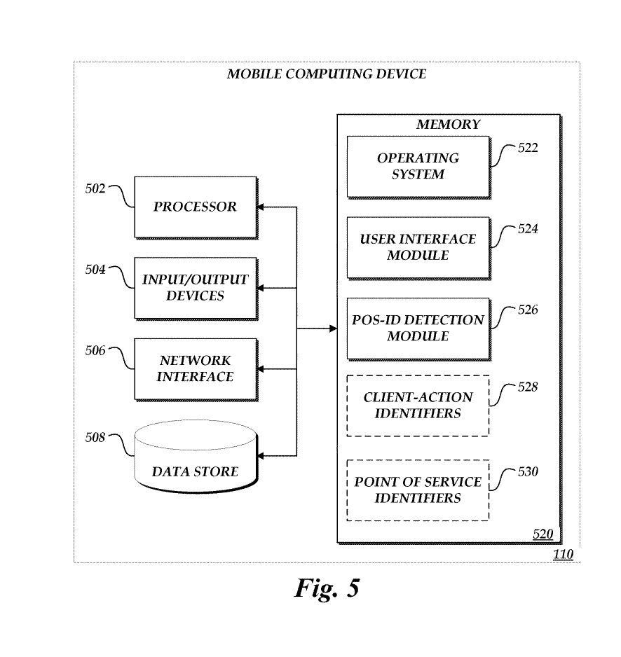

The mobile computing device 110 may generally be any computing device that is configured to implement aspects of the present disclosure, including but not limited to smartphones, tablets, e-book readers, media playback devices, laptop computers, smart watches, other wearable computing devices, or other computing devices. An example architecture of a mobile computing device 110 is described in more detail with reference to FIG. 5 below.

The illustrated network topology 100 further includes a point of service 120, which may include a networked POS device 122 and a POS identifier 124. The networked POS device 122 may illustratively be any computing hardware, sensors, software, or combinations thereof that implement aspects of the present disclosure, including but not limited to transmitting information regarding POS transactions to a networked user identification server 160. In various embodiments, the point of service identifier 124 may be internal or external to the networked POS device 122, and in some embodiments may be entirely separate from the networked POS device 122 and/or may not interact with the networked POS device 122. In some embodiments, the mobile computing device 110 may detect the point of service identifier 124 via a network, which may be the network 150 or a different network (not depicted in FIG. 1).

The network 150 may be any wired or wireless network, including but not limited to a local area network (LAN), wide area network (WAN), mesh network, cellular telecommunications network, the Internet, or any other public or private communications network or networks. In some embodiments, protocols such as WiFi, Bluetooth, LTE, GPRS, TCP/IP, UDP, Ethernet, or other protocols may be utilized by the networked POS device 122 and/or the mobile computing device 110 to communicate via the network 150. In some embodiments, the networked POS device 122 and the mobile computing device 110 may utilize different networks 150 to communicate with the user identification server 160. For example, the networked POS device 122 may communicate via a LAN, while the mobile computing device 110 may communicate via a WiFi or cellular telecommunications network.

The mobile computing device 110 and networked POS device 122 may communicate via the network(s) 150 with a user identification server 160. The user identification server may include various hardware and software components configured to implement aspects of the present disclosure, such as a user correlation module 164, a POS transaction data store 162, and a POS-ID detection data store 166. It will be understood that the user identification server 160 may include more or fewer components than those depicted in FIG. 1. For example, the POS transaction data store 162 and the POS-ID detection data store 166 may be implemented as a single data store. The user identification server may further include a processor, memory, network interface, input/output devices, and other components. In some embodiments, the user identification server may be implemented via multiple computing devices, which may not necessarily be in the same location.

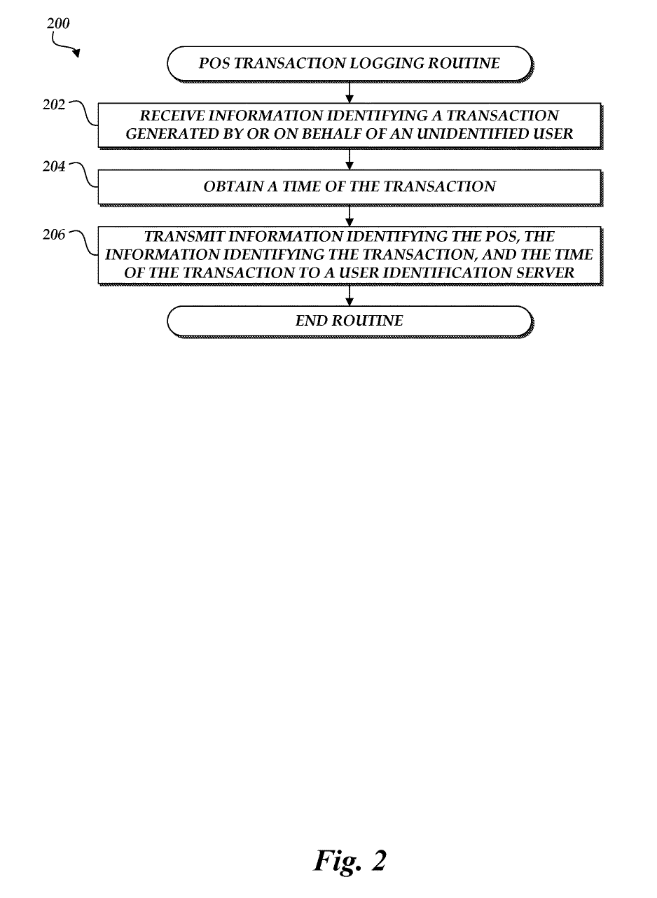

With reference now to FIG. 2, an illustrative POS transaction logging routine 200 is described. The illustrative routine 200 may be carried out, for example, by the networked POS device 122 of FIG. 1. At block 202, information identifying a transaction may be received. Illustratively, the information may include transaction data (TDATA), such as an item identifier, a quantity, a transaction cost, and/or other transaction details, but may not include information identifying the other party to the transaction (e.g., an unidentified user).

At block 204, a time associated with the transaction (TTIME) may be obtained. In some embodiments, the TTIME may be received in block 202, and block 204 may be omitted or combined with block 202. In other embodiments, the TTIME may be obtained by determining the time at which block 202 was carried out, determining the time at which block 204 was carried out (e.g., the current time), obtaining a time via a networked time server or other device, or otherwise determining a time to associate with the TDATA.

At block 206, POS-identifying information (e.g., a POS-ID), the TDATA, and the TTIME are transmitted to a user identification server, such as the user identification server 160 of FIG. 1. In some embodiments, the POS-identifying information may correspond to a point of service's POS-ID tag. In other embodiments, the information transmitted at block 206 may be a separate identifier, and the user identification server may determine a POS-ID tag to associate with the POS-identifying information. In some embodiments, the POS-identifying information may be obtained from a data store associated with the POS device.

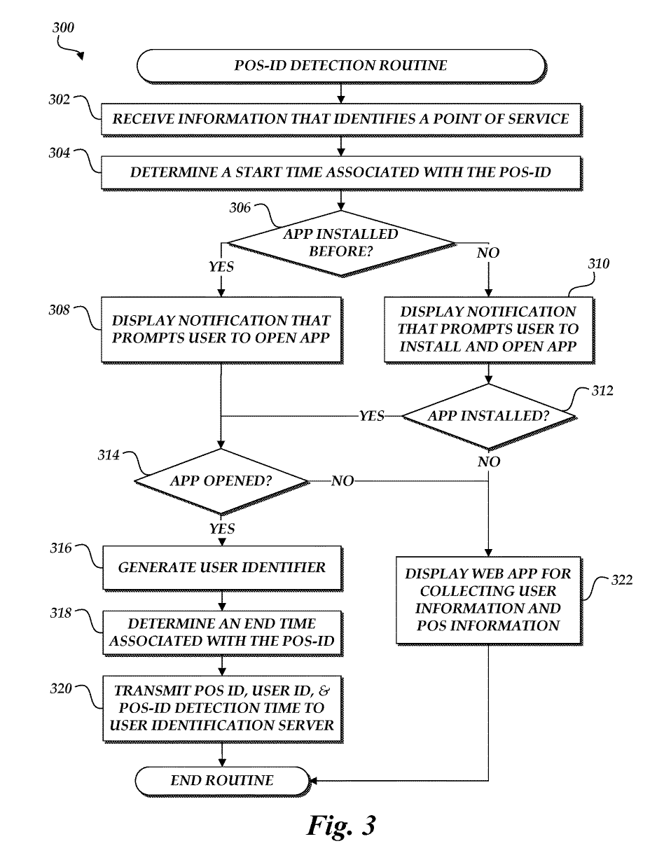

FIG. 3 depicts an illustrative routine 300 for detecting a POS-ID tag. The routine 300 may be carried out by, for example, the mobile computing device 110 of FIG. 1. At block 302, information may be received that identifies a point of service. Illustratively, as described above, the information may be received from a POS-ID tag, such as the point of service identifier 124 depicted in FIG. 1. In various embodiments, the information identifying the point of service may be received via a network interface, camera, bar code reader, or other sensor or input device.

At block 304, a start time may be associated with the POS-ID (or any other POS identifying information received at block 302). For example, a start time may be associated with the POS-ID based on a received signal strength (e.g., a Bluetooth beacon signal strength, a Wi-Fi network signal strength, etc.) exceeding a threshold, the POS-ID becoming the strongest signal of a plurality of received POS-ID signals, entering a geographic area associated with the POS-ID, and so forth. As a further example, a POS-ID start time may be associated with scanning a QR code or a bar code.

At decision block 306, in some embodiments, a determination may be made as to whether a software application that carries out blocks 316-320 of the routine 300 has been installed on the device that executes the routine 300. If the application has been installed before, the routine 300 branches to block 308, where a notification may be displayed that prompts the user to open the application. If the application has not been installed, then the routine 300 branches to block 310, where a notification may be displayed that prompts the user to install and open the application. The routine 300 then branches to decision block 312, where a determination may then be made as to whether the user has installed the application. If so, the routine 300 branches to decision block 314, and if not the routine 300 branches to block 322.

At decision block 314, a determination may be made as to whether the application has been opened in response to either the prompt at block 308 or at block 310. If so, then the routine 300 branches to block 316. If not, the routine 300 branches to block 322, where a web app may be displayed for collecting user and POS information manually.

In various embodiments, blocks 306-314 and/or 322 may be combined or omitted. For example, the software application may run in the background, and blocks 308 and 314 may be omitted. As a further example, the routine 300 may proceed directly from block 304 to block 316, and a separate application may not be installed or invoked to carry out blocks of the routine 300. As a still further example, the application may be invoked automatically (e.g., without user action) in response to the receipt of POS-ID information at block 302, and the application may carry out block 304 in addition to blocks 316-320.

At block 316, a user identifier may be generated. In some embodiments, the user identifier may be generated prior to execution of the routine 300, and may be obtained at block 316 rather than generated. In other embodiments, a CLIENT-ACTION-ID (CAI) may be created randomly, or may be based on some other pre-defined algorithm. Illustratively, the CAI may be provided and used to identify information associated with a particular user without providing information that identifies the user. The CAI may be private or public. For an example, the CAI may be generated using the RSA protocol in the mobile application.

At block 318, in some embodiments, an end time may be determined and associated with the POS-ID. For example, the POS-ID may be detected by receiving a signal, and the end time may be associated with the signal's strength falling below a threshold. As further examples, the end time associated with a POS-ID may correspond to leaving a geographic area associated with the POS-ID, with the signal associated with a POS-ID ceasing to be the strongest signal detected, with receiving information that identifies a different POS (e.g., scanning a different QR code), or based on other criteria. In some embodiments, the start time and end time associated with a POS-ID may collectively be referred to as a CTIME. In other embodiments, block 318 may be omitted and the CTIME may correspond to the time determined at block 304. That is, in various embodiments, the CTIME may be a timestamp or a time interval. At block 320, the POS-ID, CAI, and CTIME may be transmitted to a user identification server, such as the user identification server 160 of FIG. 1.

In various embodiments, the blocks of illustrative routine 300 may be combined, separated, or carried out in other orders. For example, block 318 may be carried out before block 306. As a further example, block 316 may be carried out at any time prior to block 320. As a still further example, block 322 may be omitted and the routine 300 may end if the application is not installed or is not opened in response to the prompt. Still further, block 306 may be omitted and blocks 308 and 310 may be combined, such that a notification may be displayed that prompts the user to install and/or open the application, and the notification may be displayed regardless of whether the application was previously installed.

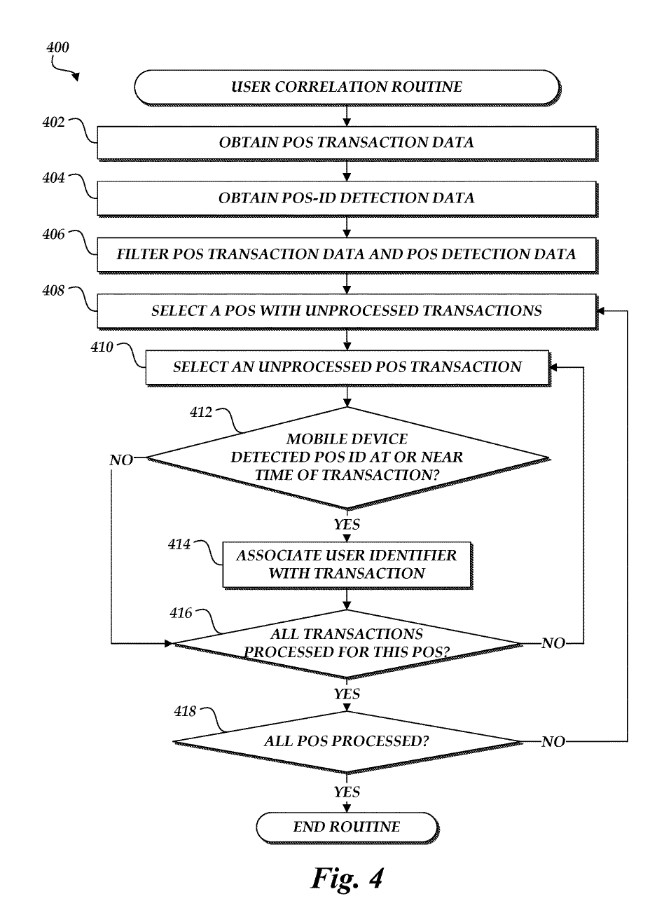

FIG. 4 depicts an illustrative routine 400 for associating the parties to a POS transaction with each other. The routine 400 may be carried out, for example, by the user identification server 160 of FIG. 1. At block 402, POS transaction data may be obtained. Illustratively, the POS transaction data may be received from a POS device, such as the networked POS device 122 of FIG. 1. In some embodiments, the POS transaction data may be transmitted by a transaction logging routine, such as the example routine 200 of FIG. 2, and may include information such as a POS-ID, TDATA, and TTIME, as described above. In other embodiments, the POS transaction data may be obtained from a data store, such as the POS transaction data store 162 of FIG. 1.

At block 404, POS-ID detection data may be obtained. Illustratively, the POS-ID detection data may be received from a mobile device, such as the mobile computing device 110 of FIG. 1. In some embodiments, the POS-ID detection data may be transmitted by a POS-ID detection routine, such as the example routine 300 of FIG. 3, and may include information such as a POS-ID, CDATA, and CTIME, as described above. In other embodiments, the POS-ID detection data may be obtained from a data store, such as the POS-ID detection data store 166 of FIG. 1.

In various embodiments, routine 400 may be carried out with new POS transaction data and previously stored POS-ID detection data, previously stored POS transaction data and new POS-ID detection data, and all other combinations of new and previously stored data. Additionally, in some embodiments, the routine 400 may defer execution of later blocks of the routine until sufficient quantities of data have been obtained at blocks 402 and/or 404, or may carry out later blocks of the routine on a periodic basis (e.g., nightly or hourly).

At block 406, POS transaction data and POS-ID detection data may be filtered. Illustratively, checks and algorithmic steps may be applied to remove duplicate data, identify and remove hacking attempts and other non-intended actions, and/or filter out transactions for which both parties have been identified.

At block 408, a point of service (and/or a POS-ID) associated with unprocessed POS transaction data may be selected. In some embodiments, as described above, a POS-ID may be determined for a point of service that the POS transaction data identifies using another identifier. At block 410, an unprocessed POS transaction may be selected from the POS transaction data for the POS-ID.

At decision block 412, a determination may be made as to whether a mobile device detected the POS-ID at a CTIME corresponding to the TTIME of the unprocessed POS transaction. Illustratively, the determination is based on the principle that when the TTIME and CTIME of the same POS-ID are within a relatively small proximity of each other in time, they belong to the same client. The confidence level increases in the case where the time difference between CTIME and TTIME is close to zero.

In one embodiment, each CTIME is matched with the closest TTIME. In another embodiment each CTIME may be matched with the closest TTIME less than or equal to it. In the plurality of these algorithms the specifics of the matching will depend on the use-case and setting in which the TTIME and CTIME were collected in order to achieve high confidence levels of accuracy. In a further embodiment, the CTIME may be a duration, as described above, and the determination may include whether the TTIME falls within or near the duration. In various embodiments, optimization methods can be used to maximize accuracy. Furthermore, by using time as the matching parameter, the TDATA can be correctly identified with high accuracy through a simple cross-referencing through a comparison between TTIME, and CTIME and the POS-ID.

The matching algorithm is used to make sure that the user receives the TDATA associated with the right transaction. The parameter of the matching algorithm can be fine-tuned to maximize the accuracy of the system. In one embodiment, this matching algorithm considers only the TDATA associated with the TTIME in a short interval before the CTIME of a particular POS-ID. Thus, the parameter in this embodiment is the length of the time window which would be of the order of few seconds to a minute and can be fine-tuned to decrease the error chances.

If the determination at decision block 412 is that a CTIME corresponds to the TTIME, then at block 414 the CAI that identifies the user of the mobile device may be associated with the TDATA. In some embodiments, the association between the CAI and the TDATA may be used to process the transaction. For example, the CAI and the associated TDATA may be provided as input to a payment system, which may transfer a payment for the transaction from an account associated with the CAI to an account associated with the POS. In further embodiments the payment system may be a third-party system, and the routine 400 may serve as an intermediary between the parties. If the determination at decision block 412 is that none of the obtained CTIMES can be associated with the TTIME of the transaction, then the routine 400 branches to decision block 416, where a determination is made as to whether further transactions involving this point of service remain to be processed. If so, then the routine 400 returns to block 410, where another unprocessed transaction may be selected, and the routine 400 iterates until all transactions for the selected point of service have been processed.

If all transactions have been processed for the selected point of service, the routine 400 branches to decision block 418, where a determination may be made as to whether all points of service have been processed. If a point of service with unprocessed transactions remains, then the routine 400 branches to block 408, where another point of service may be selected, and iterates until all points of service have been processed. If all points of service have been processed, the routine 400 ends. In some embodiments the routine 400 may output the determined correlations, some or all of which may be made available to a user, a POS operator, or other users who may have permission to access the data.

An advantage of various aspects of the present disclosure is that users may keep identifying information private from the POS operator. Prior art systems typically require that the user provide personally identifying information, such as contact information, a user ID, credit card number, or other personal data, to the POS in order to complete a transaction. By separating user identifying information from POS identifying information, in some embodiments, the user can exercise more control over whether and which user information is obtained by the point of service device.

FIG. 5 depicts a general architecture of a mobile computing device 110, which includes an arrangement of computer hardware and software components that may be used to implement aspects of the present disclosure. The mobile computing device 110 may include many more (or fewer) elements than those shown in FIG. 5. It is not necessary, however, that all of these elements be shown in order to provide an enabling disclosure.

As illustrated, the mobile computing device 110 includes a processor 502, input/output devices 504, a network interface 506, and a data store 508, all of which may communicate with one another by way of a communication bus. The network interface 506 may provide connectivity to one or more networks (such as network 150 of FIG. 1) or computing systems and, as a result, may enable the mobile computing device 110 to receive and send information and instructions from and to other computing systems or services, such as the user identification server 160 of FIG. 1.

The processor 502 may also communicate to and from a memory 520. The memory 520 may contain computer program instructions (grouped as modules or components in some embodiments) that the processor 502 may execute in order to implement one or more embodiments. The memory 520 generally includes RAM, ROM, and/or other persistent, auxiliary, or non-transitory computer-readable media. The memory 520 may store an operating system 522 that provides computer program instructions for use by the processor 502 in the general administration and operation of the mobile computing device 110. The memory 520 may further store specific computer-executable instructions and other information (which may be referred to herein as “modules”) for implementing aspects of the present disclosure. For example, the memory 520 may include a user interface module 524, which may perform various operations with regard to displaying the user interfaces described herein. For example, the user interface module 524 may manage the display of notifications that POS-IDs have been obtained.

In some embodiments, the memory 520 may include a POS-ID detection module 526, which may be executed by the processor 502 to perform various operations, such as those operations described with reference to FIG. 3. The memory 520 may further include client-action identifiers (CAIs) 528 and POS identifiers 530 that are loaded into the memory 520 as various operations are performed. The CAIs 528 may be generated based on user profiles or other information stored in the data store 508 or provided via the input/output devices 504. In some embodiments, a single CAI 528 may be generated for a particular user, while in other embodiments a different CAI 528 may be generated on a per-POS basis, a periodic basis, or based on other criteria. POS identifiers may illustratively be loaded into the memory as they are detected by the POS-ID detection module 524.

While the operating system 522, the user interface module 524, and the POS-ID detection module 526 are illustrated as distinct modules in the memory 520, in some embodiments, the user interface module 524 and the POS-ID detection module 526 may be incorporated as modules in the operating system 522 or another application or module, and as such, separate modules may not be required to implement some embodiments. In some embodiments, the user interface module 524 and the POS-ID detection module 526 may be implemented as parts of a single application.

The mobile computing device 110 may connect to one or more networks via the network interface 506. The networks may be any wired or wireless networks, including but not limited to local area networks (LANs), wide area networks (WANs), mesh networks, cellular telecommunications networks, the Internet, or any other public or private communications network or networks. In some embodiments, the network interface 506 may utilize protocols such as WiFi, Bluetooth, LTE, GPRS, TCP/IP, UDP, Ethernet, or other protocols to communicate via the network(s).

It will be recognized that many of the components described in FIG. 5 are optional and that embodiments of the mobile computing device 110 may or may not combine components. Furthermore, components need not be distinct or discrete. Components may also be reorganized. For example, the mobile computing device 110 may be represented in a single physical device or, alternatively, may be split into multiple physical devices. In some embodiments, components illustrated as part of the mobile computing device 110 (such as the data store 508) may additionally or alternatively be included in other computing devices, such that some aspects of the present disclosure may be performed by the mobile computing device 110 while other aspects are performed by another computing device.

Depending on the embodiment, certain elements, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or the entire signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A system comprising:
a data store configured to store point of service transaction data; and
a computing system including a processor in communication with the data store, wherein the processor executes specific computer-executable instructions to at least:
receive, from a mobile computing device, information indicating that the mobile computing device has detected a first point of service identifier;
determine, based at least in part on the information received from the mobile computing device, a first timestamp for detection of the first point of service identifier by the mobile computing device;
receive, from a point of service computing device, point of service transaction data, the point of service transaction data including at least the first point of service identifier and information regarding a first transaction;
determine, based at least in part on the information regarding the first transaction, a second timestamp for the first transaction;
determine, based at least in part on the first timestamp and the second timestamp, that the mobile computing device is associated with the first transaction;
receive, from the mobile computing device, a request for transaction data associated with the mobile computing device; and
in response to the request for transaction data associated with the mobile computing device, and in response to the determination that the mobile computing device is associated with the first transaction, transmit the information regarding the first transaction to the mobile computing device.

2. The system of claim 1, wherein the processor further executes specific computer-executable instructions to at least store the point of service transaction data in the data store.

3. The system of claim 1, wherein the computer-executable instructions that cause the processor to determine that the mobile computing device is associated with the first transaction cause the processor to determine that the first timestamp and the second timestamp are within a threshold interval of each other.

4. The system of claim 1, wherein the computer-executable instructions further cause the processor to determine a time interval during which the mobile computing device detected the first point of service identifier.

5. The system of claim 4, wherein the computer-executable instructions that cause the processor to determine that the mobile computing device is associated with the first transaction cause the processor to determine that the second timestamp is within the time interval.

6. The system of claim 1, wherein the processor further executes specific computer-executable instructions to at least:
receive, from the point of service computing device, a request to identify the mobile computing device associated with the first transaction; and
transmit, to the point of service computing device, information identifying the mobile computing device.

7. A computer-implemented method comprising:
receiving, by a networked user identification server, information from a first mobile computing device, wherein the information indicates detection of a first point of service identifier, and wherein the information identifies a first user of the mobile computing device;
obtaining, by the networked user identification server, a first timestamp associated with detection of the first point of service identifier;
receiving, by the networked user identification server, a first set of transaction data from a point of service computing device;
obtaining, by the networked user identification server, point of service identification information, wherein the point of service identification information associates individual points of service with corresponding point of service identifiers;
determining, based at least in part on the point of service identification information, that the point of service computing device corresponds to the first point of service identifier;
determining, based at least in part on the first set of transaction data, a second timestamp associated with the first set of transaction data;
determining, based at least in part on the first timestamp and the second timestamp, that the first user is associated with the first set of transaction data; and
transmitting the first set of transaction data to the first mobile computing device.

8. The computer-implemented method of claim 7, wherein the information from the mobile computing device includes the first timestamp.

9. The computer-implemented method of claim 7, wherein the first point of service identifier comprises an RFID tag, a NFC tag, a Bluetooth device, a Bluetooth LE device, a Wi-Fi device, a bar code, or a QR code.

10. The computer-implemented method of claim 7 further comprising:
receiving, by the networked user identification server, information from a second mobile computing device, wherein the information indicates detection of the first point of service identifier, and wherein the information identifies a second user of the second mobile computing device;
obtaining, by the networked user identification server, a third timestamp associated with detection of the first point of service identifier by the second mobile computing device;
receiving, by the networked user identification server, a second set of transaction data from the point of service computing device;
determining, based at least in part on the second set of transaction data, a fourth timestamp associated with the second set of transaction data;
determining, based at least in part on the third timestamp and the second timestamp, that the second user is not associated with the first set of transaction data;
determining, based at least in part on the third timestamp and the fourth timestamp, that the second user is associated with the second set of transaction data; and
transmitting the second set of transaction data to the second mobile computing device.

11. The computer-implemented method of claim 10, wherein determining that the second user is not associated with the first set of transaction data is further based at least in part on the first timestamp.

12. A computer-implemented method comprising:
detecting, by a mobile computing device, a first point of service identifier;
in response to detecting the first point of service identifier, causing the mobile computing device to execute an application for accessing transaction data;
transmitting, by the mobile computing device, information regarding detection of the first point of service identifier to a networked user identification server;
transmitting, by the mobile computing device, a request for transaction data;
receiving, by the mobile computing device, transaction data associated with the mobile computing device; and
causing the mobile computing device to display the transaction data.

13. The computer-implemented method of claim 12, wherein causing the mobile computing device to execute the application for accessing transaction data comprises prompting a user to install the application on the mobile computing device.

14. The computer-implemented method of claim 12, wherein the information regarding detection of the first point of service identifier comprises a timestamp, a duration, and the first point of service identifier.

15. The computer-implemented method of claim 12, wherein the transaction data associated with the mobile computing device is further associated with the point of service identifier.

16. The computer-implemented method of claim 12 further comprising:
detecting, by the mobile computing device, a second point of service identifier, wherein:
detecting the first point of service identifier occurs during a first time interval;
detecting the second point of service identifier occurs during a second time interval; and
the first time interval at least partially overlaps the second time interval; and
determining, by the mobile computing device, that the information regarding detection of the first point of service identifier should be transmitted instead of information regarding detection of the second point of service identifier.

17. The computer-implemented method of claim 16, wherein determining that the information regarding detection of the first point of service identifier should be transmitted comprises:
measuring a first signal strength associated with the first point of service identifier;
measuring a second signal strength associated with the second point of service identifier; and
determining that the first signal strength exceeds the second signal strength.

18. The computer-implemented method of claim 16, wherein determining that the information regarding detection of the first point of service identifier should be transmitted comprises:
presenting information regarding the first point of service identifier and the second point of service identifier to the user; and
receiving user input indicating selection of the first point of service identifier.

19. The computer-implemented method of claim 12, wherein the transaction data is further associated with a user of the mobile computing device.

20. The computer-implemented method of claim 19 further comprising identifying the user of the mobile computing device.
